(19) United States
(12) Patent Application Publication
(10) Pub. No.: US 2026/0129251 A1
(43) Pub. Date: May 7, 2026

(54) SYSTEMS AND METHODS FOR REDUCING SERVER LOAD

(71) Applicant: Comcast Cable Communications, LLC, Philadelphia, PA (US)

(72) Inventors: Alexander GILADI, Denver, CO (US); Johnathon Wesley BENTON, Evergreen, CO (US); Alexander Leo BALK, Edmonds, WA (US)

(21) Appl. No.: 19/368,619

(22) Filed: Oct. 24, 2025

Related U.S. Application Data
(60) Provisional application No. 63/715,451, filed on Nov. 1, 2024.
(60) Provisional application No. 63/738,263, filed on Dec. 23, 2024.

(51) Int. Cl. H04N 21/239; H04N 21/262; H04N 21/437; H04N 21/845; H04N 21/858

(52) U.S. Cl. CPC H04N 21/2393; H04N 21/26241; H04N 21/437; H04N 21/8456; H04N 21/8586

(57) ABSTRACT

Methods and systems for reducing server load are disclosed. At least one server may receive a request from a client device for a first segment of a plurality of segments of a content item. A first randomly selected quantity of additional segments of the plurality of segments may be determined based on a manifest associated with the content item. The first segment and the first randomly selected quantity of additional segments may be sent to the client device.

### CROSS-REFERENCE TO RELATED APPLICATIONS

This application claims the benefit of U.S. Patent Application No. 63/715,451, filed Nov. 1, 2024, and U.S. Patent Application No. 63/738,263, filed Dec. 23, 2024, both of which are hereby incorporated by reference in their entireties for any and all purposes.

### BACKGROUND

A large quantity of users may want to simultaneously view the same content item. A client device associated with each of the users may request segments of the content item from a server, thereby causing the server to receive a large quantity of simultaneous requests for the same segment(s). This flood of simultaneous requests may degrade performance of the server.

### SUMMARY

Methods and systems for reducing server load are disclosed. A large quantity of users simultaneously may be viewing the same content item. Instead of the client devices associated with the users all requesting the same segment of the content item from a server at the same time, each of the client devices may request a different, random number of future segments of the content item, together with the nearest segment, from the server. Randomizing the quantity of segments requested by each client device may prevent the server from receiving a large quantity of simultaneous requests for the same content segment, thereby decreasing the load on the server.

Alternatively, or in addition to, each of the client devices requesting a different, random number of future segments of the content item, together with the nearest segment, from the server, the client devices may all request a first segment of the content item from a server at the same time. Instead of sending only the first segment to each of the client devices, the server may send a different, random number of future segments of the content item, together with the requested first segment, to each of the client devices. Randomizing the quantity of segments sent to each client device may prevent the client devices from simultaneously requesting the next segment (e.g., the segment immediately following the first segment), thereby preventing the server from receiving a large quantity of simultaneous requests for the next content segment.

Alternatively, or in addition to, simultaneously sending a first requested segment of the same content item to a large quantity of users that are simultaneously viewing the content item, the server may send the first segment to each of the client devices at a random, different time. Randomizing the time at which the first segment is sent to each client device may cause the client devices to request the next segment (e.g., the segment immediately following the first segment) at slightly different times, thereby preventing the server from receiving a large quantity of simultaneous requests for the next content segment.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an example system.

FIG. 2 shows an example method.

FIG. 3 shows an example method.

FIG. 4 shows an example method.

FIG. 5 shows an example method.

FIG. 6 shows an example method.

FIG. 7 shows an example method.

FIG. 8 shows an example method.

FIG. 9 shows an example method.

FIG. 10 shows an example method.

FIG. 11 shows an example method.

FIG. 12 shows an example computing device.

### DETAILED DESCRIPTION

Methods and systems for reducing server load are disclosed. The rising demand for live low-latency streaming puts a significant strain on servers (e.g., Hypertext Transfer Protocol (HTTP) servers). If a large quantity of users attempt to simultaneously stream the same content item, a server may receive a large quantity of tightly synchronized requests for the same content segment. This flood of simultaneous requests may degrade the performance of the server. To prevent the server from receiving a flood of simultaneous requests, the quantity of content segments being requested by client devices (e.g., playback device, output device, etc.) may be randomized, such that each client device may request a different, randomly selected quantity of content segments from the server. If each client device is able to request a different, randomly selected quantity of segments from the server, the server may receive fewer simultaneous requests for the same content segment, thereby reducing the load on the server.

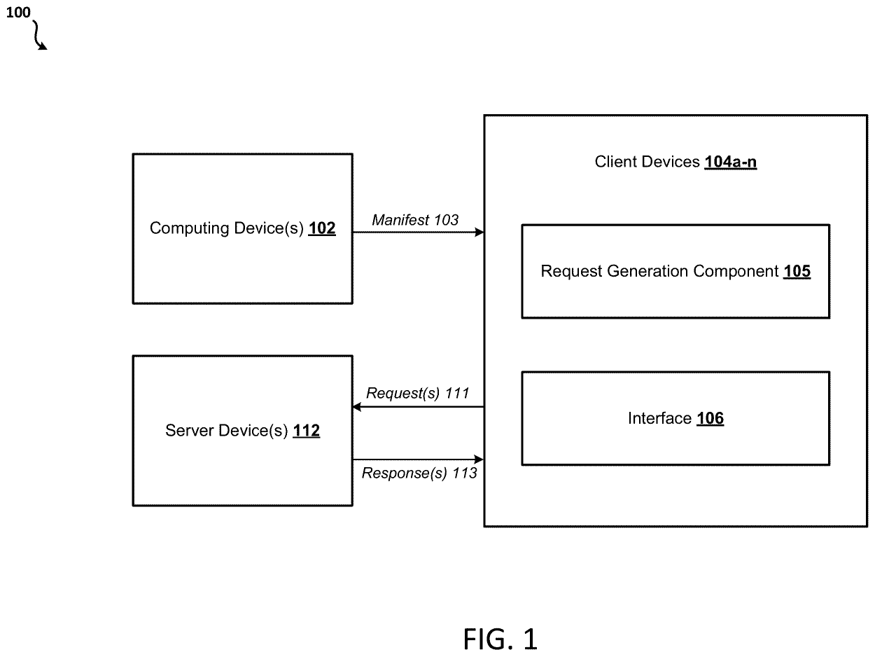

FIG. 1 shows an example system 100 for content output. The system 100 may comprise one or more computing devices 102, a plurality of client devices 104a-n, and one or more servers 112. The system 100 may be used to facilitate the output of linear content. For example, the system 100 may be used to facilitate the live streaming of a content item (e.g., using Dynamic Adaptive Streaming over HTTP (DASH), MPEG-DASH, or HTTP Live Streaming (HLS) by the plurality of client devices 104a-n.

The computing device(s) 102 may comprise a manifest manipulator device, such as one or more devices configured to write and/or re-write manifests. The computing device(s) 102 may be located at an origin server associated with a content delivery network, a packager associated with the content delivery network, a node associated with the content delivery network, or co-located, such as with a virtualized cable modem termination system (CMTS) location.

The computing device(s) 102 may be configured to generate or receive a manifest 103 associated with a content item. The content item may comprise a linear content item, such as a live content stream (e.g., live linear video and/or audio content). The manifest 103 may comprise a media presentation description (MPD) (e.g., a MPEG-DASH manifest file). The computing device(s) 102 may receive the manifest 103 from a MPD generator, a DASH packager, or any other device configured to generate the manifest 103 associated with the content item. The computing device(s) 102 may send the manifest 103 to each of the plurality of client devices 104a-n.

The manifest 103 may contain information describing various aspects of each segment of the content item that may be useful for the client devices 104a-n to request, receive, and cause output (e.g., playback) of the content item. The manifest 103 may comprise data indicating the length (e.g., size, duration) of the segments of the content item. The manifest 103 may contain network location information associated with each segment of the content item. The network location information associated with a particular segment may indicate a future network location associated with the segment, even if the segment has not yet been created. The network location information may comprise, for example, a uniform resource locator (URL) associated with the segment. For example, the manifest 103 may contain a predictive template (e.g., using the SegmentTemplate@duration or S@r=−1). The predictive template may contain the data indicating the length (e.g., size, duration) of the segments of the content item and/or the network location information.

The manifest 103 may contain information indicating a range of quantities. The range of quantities may indicate a number of segments of the content item that may be requested at one time. The range of quantities of segments may be determined based at least in part on the length (e.g., size, duration) of the segments of the content item. For example, the minimum and maximum values of the range of quantities randomized range may be determined based at least in part on the length (e.g., size, duration) of the segments of the content item. The range of quantities may be determined by the computing device(s) 102 or by a device from which the computing device(s) received the manifest 103. The manifest 103 may contain a value of a seed for a random pseudo-number generator.

If the manifest 103 is an MPD, the manifest 103 may comprise one or more elements (e.g., containers, period elements, XML elements, etc.) that each correspond to a particular segment of the content item. The element corresponding to a particular segment of the content item may contain information describing various aspects of the corresponding segment that may be useful for the client devices 104a-n to cause output (e.g., playback) of the corresponding segment. For example, the element corresponding to a particular segment of the content item may contain the network location information (e.g., a HTTP URL link) associated with the segment.

Each of the plurality of client devices 104a-n may receive the manifest 103. Each of the plurality of client devices 104a-n may comprise a request generation component 105. Each request generation component 105 may determine, based on the manifest 103, a randomly selected quantity of segments of the content item. Each request generation component 105 may determine, based on the manifest 103, a different randomly selected quantity of segments of the content item. The randomly selected quantity of segments of the content item may comprise a randomly selected quantity of consecutive segments of the content item. To determine the randomly selected quantity of segments of the content item, each of the request generation components 105 may select a random number R from the range of quantities indicated by the manifest 103. Each of the request generation components 105 may select a different random number R from the range of quantities indicated by the manifest 103. Each of the request generation components 105 may determine the randomly selected quantity of segments using a random pseudo-number generator and a given seed value for the random pseudo-number generator (as indicated by the manifest 103 or HTTP headers). Each of the request generation components 105 may determine, based on the manifest 103, the network location information (e.g., the URL) associated with each of the R segments.

For example, the range of quantities indicated by the manifest 103 may comprise quantities in the range from 3 segments to 10 segments. The request generation component 105 of the client device 104a may randomly select the quantity “3” from the range, such that R=3. The request generation component 105 of the client device 104a may determine, based on the network location information contained in the manifest, the URL associated with the next three segments of the content item (e.g., the nearest segment and the two segments following the nearest segment). For example, the predictive template contained in the manifest may indicate that a URL of the first of the three segments ends with “. . . 42,” and that for each subsequent consecutive segment, the URL can be generated by incrementing the ending value by 1. For example, the URL of the next segment after the first would end with “. . . 43,” and the segment after that would end with “. . . 44.” In this manner, the client device 104a is able to generate the request comprising the URLs of each segment even though the subsequent segments may not yet be available to be delivered to the client device 104a.

Similarly, the request generation component 105 of the client device 104b may randomly select the quantity “7” from the range, such that R=7. The request generation component 105 of the client device 104b may determine, based on the network location information contained in the manifest, the URL associated with the next seven segments of the content item (e.g., the nearest segment and the six segments following the nearest segment). For example, the predictive template contained in the manifest may indicate that a URL of the first of the seven segments ends with “. . . 44,” and that for each subsequent consecutive segment, the URL can be generated by incrementing the ending value by 1. For example, the URL of the next segment after the first would end with “. . . 45,” the segment after that would end with “. . . 46,” and so on. In this manner, the client device 104b is able to generate the request comprising the URLs of each segment even though the subsequent segments may not yet be available to be delivered to the client device 104b.

Each of the request generation components 105 may generate one or more requests 111 based on the randomly selected quantity of segments of the content item. The request(s) 111 may comprise a single request (e.g., a single HTTP GET request). The request generation component 105 of one or more of the plurality of client device(s) 104a-n, such as one or more of the plurality of client devices 104a-n that use HTTP/1.1, may generate a single request for the randomly selected quantity of segments. To generate the single request, these request generation component(s) 105 may build, based on the predictive template contained in the manifest, a list or table of tuples [(t(i), URI(i)], where i ranges from 1 to R, where uniform resource indicator (URI) is the URI (e.g., HTTP(S) URL) of the requested i-th media segment or partial media segment, and t is the deadline by which the corresponding client device needs to receive that segment for successful output. The request generation component(s) 105 may apply lossless compression (e.g., Brotli) to the list or table of tuples. The request generation component(s) 105 may generate the single request (e.g., HTTP GET request) based on the compressed list or table of tuples. The request generation component(s) 105 may send the single request to the server(s) 112. The request generation component(s) 105 may optionally include a token in the single request or may send a token to the server(s) 112 alongside the single request. The token may be utilized by the server(s) 112 to verify the identity of the requesting client device.

The one or more requests 111 may comprise a plurality of requests (e.g., a plurality of HTTP GET requests). The request generation component 105 of one or more of the plurality of client device(s) 104a-n, such as one or more of the plurality of client devices 104a-n use HTTP/2 or HTTP/3, may generate a plurality of requests for the randomly selected quantity of segments. Each of the plurality of requests may comprise a request for an individual segment among the randomly selected quantity of segments. For example, if the request generation component 105 of the client device 104a randomly selected R=3, the request generation component 105 of the client device 104a may generate three requests for sending to the server(s) 112: a first request for the nearest segment (e.g., the first segment), a second request for the segment immediately following the first segment (e.g., the second segment), and a third request for the segment immediately following the second segment (e.g., the third segment). Each of the plurality of requests may contain the network location information (e.g., URL) associated with the corresponding segment. The request generation component(s) 105 may send the plurality of requests to the server(s) 112. The request generation component(s) 105 may optionally include a token in each of the plurality of requests or may send a token to the server(s) 112 alongside the plurality of requests. The token may be utilized by the server(s) 112 to verify the identity of the requesting client device.

If one or more of the plurality of client device(s) 104a-n supports HTTP/3 server push, these client device(s) may effectively request the randomly selected quantity of segments by including the network location information (e.g., URLs) of the R segments in a query parameter.

The server(s) 112 may receive the request(s) 111 from the plurality of client device(s) 104a-n. The server(s) 112 may send, to the plurality of client devices 104a-n, one or more responses 113 to the request(s) 111. The response(s) 113 may comprise the randomly selected quantity of segments. Because each of the request(s) 111 may comprise one or more requests for a different randomly selected quantity of segments of the content item, each of which may have a different cumulative duration, the total quantity of requests 111 received by the server(s) 112 at any given time is reduced. For example, the server(s) 112 are less likely to receive a flood of simultaneous requests for the same segment. Reducing the total quantity of requests 111 received by the server(s) 112 at any given time may decrease the load on the server(s) 112.

The server(s) 112 may send each of the randomly selected quantity of segments to the respective client device(s) 104a-n in a separate response as the segments become available. For example, the server(s) 112 may send each requested segment as an HTTP chunk when the segment becomes available, until the last of the requested segments is available or the client device closes the HTTP connection with the server(s) 112. If the server(s) receive a request 111 for a segment prior to the availability of that segment, the server(s) 112 may wait until the segment becomes available (or until some timeout is reached) before sending the response 113 to the request 111.

The server(s) 112 may determine to wait until the segment becomes available based on determining that the request(s) 111 contain the token and/or were sent along with the token, thereby reducing the likelihood of this feature being used for Distributed Denial of Service (DDOS) attacks. If the server(s) 112 determine that the request(s) 111 do not contain the token and/or were not sent along with the token, the server(s) 112 may ignore the request(s) 111 instead of waiting for the segment to become available.

For example, if the client device 104c randomly selected R=4, the server(s) 112 may receive, from the client device 104c, one or more requests 111 for four segments: the nearest segment (e.g., the first segment), the segment immediately following the first segment (e.g., the second segment), the segment immediately following the second segment (e.g., the third segment), and the segment immediately following the third segment (e.g., the fourth segment). The server(s) 112 may respond to the request(s) 111 based on sending the first segment to the client device 104c at a first time. The server(s) 112 may send the first segment to the client device 104c at the first time based on determining that the first segment is available (e.g., has been created or is otherwise accessible to the server(s) 112) at the first time. The second segment, third segment, and/or fourth segment may not yet be available at the first time. The server(s) 112 may send the second segment to the client device 104c at a second time (occurring after the first time) based on determining that the second segment is available (e.g., has been created) at the second time. The third segment and/or fourth segment may not yet be available at the second time. The server(s) 112 may send the third segment to the client device 104c at a third time (occurring after the second time) based on determining that the third segment is available (e.g., has been created) at the third time. The fourth segment may not yet be available at the third time. The server(s) 112 may send the fourth segment to the client device 104c at a fourth time (occurring after the third time) based on determining that the fourth segment is available (e.g., has been created) at the fourth time.

If one or more of the plurality of client devices 104a-n sent a single request (e.g., HTTP GET request) to fetch all R segments, and the network location information (e.g., URLs) of the R segments is contained in the query parameters or headers of the request, the server(s) 112 may return the R segments in the order that the R segments appear in the parameters. The server(s) 112 may respond with a regular HTTP response using chunked transfer encoding. For example, the server(s) 112 may send each requested segment as an HTTP chunk when the segment becomes available, until the last of the requested segments is available, the requested segment is unavailable, or the client device closes the HTTP connection. Alternatively, the server(s) 112 may respond with a PUSH_PROMISE frame and may send each requested segment using server push.

One or more of the plurality of client devices 104a-n may allow the server(s) 112 to switch bitrates by supplying alternative lists of segments. The server(s) 112 may select which bitrate to use for a segment of the randomly selected quantity of segments based on the server-client connection state (e.g., by examining a state of the Transmission Control Protocol (TCP) buffers). The server(s) 112 may select which bitrate to use for a segment of the randomly selected quantity of segments if the content item is packaged such that plain concatenation of segments results in a compliant stream. For example, the server(s) 112 may select which bitrate to use for a segment of the randomly selected quantity of segments if all representations of the content item have same track id and headers are carried in segments (e.g., in “avc3” and “hev1” packaging). The server(s) 112 may select which bitrate to use for a segment of the randomly selected quantity of segments based on a network connection of corresponding client device (e.g., based on the network connection having sufficient and stable throughput and latency). If the network connection indicates that the client device may experience frequent bitrate shifts as a result of network conditions, the server(s) 112 may redirect the client to a non-low latency service where a higher degree of buffering will negate some of the effects of network instability.

Each of the plurality of client devices 104a-n may be configured to receive the response(s) 113 including the requested segments from the server(s) 112. Each of the plurality of client devices 104a-n may cause output of the segments via an interface 106. Each of the plurality of client devices 104a-n may cause output of the segments in real time (e.g., as the segments are received from the server(s) 112).

Based on receiving the response(s) 113 including the R requested segments from the server(s) 112, each of the plurality of client devices 104a-n may determine a new random value for R and repeat the above described process. For example, based on determining that the R requested segments have been received, the request generation component 105 of the client device 104a may determine a new randomly selected quantity of segments of the content item. To determine the new randomly selected quantity of segments of the content item, the request generation component 105 may select a new random number R from the range of quantities indicated by the manifest 103. The new random number R may be the same as, or different from, the random number R determined by the request generation component 105 of the client device 104a in the first iteration. The request generation component 105 may send one or more requests for the new randomly selected quantity of segments to the server(s) 112, and the server(s) 112 may send the segments back to the client device 104a as the segments become available. Each of the plurality of client devices 104a-n may repeat this process until output of the content item is terminated, a requested segment is unavailable, or the client device terminates the connection with the server(s) 112.

If any of the plurality of client devices 104a-n detects a need to switch to a different representation of the content item and/or a need to request segments from a different server before all R segments are received, the client device may terminate the latest request(s) for any of the R segments that have not yet been received. For client devices that utilize HTTP/1.1, such client devices may terminate the latest request(s) by aborting the connection with the server(s) 112. For client devices that utilize HTTP/2 or HTTP/3, such client devices may terminate the latest request(s) by sending a GOAWAY frame to the server(s) 112. For client devices that support server push, such client devices may terminate the latest request(s) by sending a CANCEL_PUSH frame. Based on terminating the latest request(s), the client device may request any of the R segments that were not already received (and optionally a random number of following segments) from a different representation and/or server. For example, the client device may request any of the R segments that were not already received (and optionally a random number of following segments) prior to shutting down the connection with the server(s) 112.

Alternatively, or in addition, the server(s) 112 may send, to each of the plurality of client devices 104a-n, a different, randomly selected quantity of content segments without the plurality of client devices 104a-n requesting the different, randomly selected quantity of content segments. If the server(s) 112 receive a first request for the nearest segment of the content item from each of the plurality of client devices 104a-n, the server(s) 112 may send a response to the first request that includes both the nearest segment and an additional randomly selected quantity of content segments to each of the plurality of client devices 104a-n.

The server(s) 112 may comprise a response generation component that is similar to the request generation component 105. The response generation component may determine (e.g., based on the manifest 103) a different randomly selected quantity of segments of the content item to send to each of the plurality of client devices 104a-n. Each of the randomly selected quantity of segments of the content item may comprise a randomly selected quantity of consecutive segments of the content item. To determine each of the randomly selected quantity of segments of the content item, the server(s) 112 may select a random number R from the range of quantities indicated by the manifest 103. To determine each of the randomly selected quantity of segments of the content item, the server(s) 112 may use a random pseudo-number generator and a given seed value for the random pseudo-number generator (as indicated by the manifest 103 or HTTP headers). The server(s) 112 may determine, based on the manifest 103, the network location information (e.g., the URL) associated with each of the R segments.

For example, the range of quantities indicated by the manifest 103 may comprise quantities in the range from 3 segments to 10 segments. The server(s) 112 may randomly select the quantity “3” from the range for the client device 104a, such that R=3 for the client device 104a, indicating that the server(s) 112 may send three segments of the content item to the client device 104a in response to the client device 104a requesting a single segment of the content item. Similarly, the server(s) 112 may randomly select the quantity “7” from the range for the client device 104b, such that R=7 for the client device 104b, indicating that the server(s) 112 may send seven segments of the content item to the client device 104b in response to the client device 104b requesting a single segment of the content item.

The server(s) 112 may send each of the randomly selected quantity of segments to the respective client device(s) 104a-n in a separate response to the first request as the segments become available. For example, the server(s) 112 may send each segment as an HTTP chunk when the segment becomes available, until the last of the randomly selected quantity of segments is available or the client device closes the HTTP connection with the server(s) 112. The server(s) 112 may send an indication to each of the plurality of client devices 104a-n based on sending the last of the randomly selected quantity of segments to that client device. If a client device uses HTTP/1.1, the indication may comprise a zero-byte response that signals to the client device that the transfer is complete and/or that instructs the client device to initiate a new request for the next segment. If a client device uses HTTP/2.0 or HTTP/3.0, the indication may comprise a “go away” signal that signals to the client device that the transfer is complete and/or that instructs the client device to initiate a new request for the next segment.

The server(s) 112 may select which bitrate to use for a segment of the randomly selected quantity of segments based on the server-client connection state (e.g., by examining a state of the Transmission Control Protocol (TCP) buffers). The server(s) 112 may select which bitrate to use for a segment of the randomly selected quantity of segments if the content item is packaged such that plain concatenation of segments results in a compliant stream. For example, the server(s) 112 may select which bitrate to use for a segment of the randomly selected quantity of segments if all representations of the content item have same track id and headers are carried in segments (e.g., in “avc3” and “hev1” packaging). The server(s) 112 may select which bitrate to use for a segment of the randomly selected quantity of segments based on a network connection of corresponding client device (e.g., based on the network connection having sufficient and stable throughput and latency). If the network connection indicates that the client device may experience frequent bitrate shifts as a result of network conditions, the server(s) 112 may redirect the client to a non-low latency service where a higher degree of buffering will negate some of the effects of network instability.

Each of the plurality of client devices 104a-n may be configured to receive the response(s) including the randomly selected quantity of segments from the server(s) 112. Each of the plurality of client devices 104a-n may cause output of the segments via an interface 106. Each of the plurality of client devices 104a-n may cause output of the segments in real time (e.g., as the segments are received from the server(s) 112).

Based on receiving the response(s) including the randomly selected quantity of segments from the server(s) 112 (e.g., based on receiving the indication that the transfer is complete) each of the plurality of client devices 104a-n may request the next nearest segment and repeat the above described process. For example, after each of the plurality of client devices 104a-n receive the different randomly selected quantity of content segments in response to the first request, each of the plurality of client devices 104a-n may send a second request to the server(s) 112 for the next nearest segment of the content item. Because each of the plurality of client devices 104a-n may receive a different randomly selected quantity of content segments in response to the first request, each of the plurality of client devices 104a-n may send the second request to the server(s) 112 at a different time, thereby reducing the total quantity of requests received by the server(s) 112 at any given time and decreasing the load on the server(s) 112.

Alternatively, or in addition, the server(s) 112 may randomize the time at which a response including a content segment is sent to each of the plurality of client devices 104a-n. If the server(s) 112 receive a request for the nearest (e.g., first) segment of the content item from each of the plurality of client devices 104a-n, instead of simultaneously sending a response including the first segment to each of the plurality of client devices 104a-n, the server(s) 112 may send a response including the first segment to each of the plurality of client devices 104a-n at a different time. The different times may all occur within a predetermined window of time (e.g., a two second window, a three second window, etc.) The predetermined window of time may comprise, for example, the prefetching period. The prefetching period may refer to the time period in between a client requesting the first segment of the content item before the first segment is actually needed for output (e.g., playback).

The server(s) 112 may determine a different times (e.g., within the predetermined window of time) at which to send the response to each of the plurality of client devices 104a-n. The server(s) 112 may determine the different times so as to disperse or distribute (e.g., evenly distribute) the different times across the predetermined window of time. The server(s) 112 may the response comprising the first segment to each of the plurality of client devices 104a-n at the respective time as the segments become available. For example, the server(s) 112 may send the first segment to each of the plurality of client devices 104a-n as an HTTP chunk at the respective time when the segment becomes available. By sending the first segment to each of the plurality of client devices 104a-n at different times, the server(s) 112 avoids the need to simultaneously process all of the requests received at the server(s) 112.

Each of the plurality of client devices 104a-n may be configured to receive the response comprising the first segment from the server(s) 112. Each of the plurality of client devices 104a-n may cause output of the first segment via an interface 106. Each of the plurality of client devices 104a-n may cause output of the first segment in real time (e.g., as the first segment is received from the server(s) 112).

Based on receiving the response including the first segment from the server(s) 112, each of the plurality of client devices 104a-n may request the next nearest segment (e.g., the second segment) and repeat the above described process. For example, after each of the plurality of client devices 104a-n receive the first segment in response to the first request, each of the plurality of client devices 104a-n may send a second request to the server(s) 112 for the second segment. Because each of the plurality of client devices 104a-n may receive the first segment at a different time, each of the plurality of client devices 104a-n may send the second request to the server(s) 112 at a different time, thereby reducing the total quantity of requests received by the server(s) 112 at any given time and decreasing the load on the server(s) 112.

The different approaches for reducing the load on the server described above can be used in combination with each other. For example, in addition to each of the client devices 104a-n requesting a different, random number of future segments of the content item from the server(s) 112, the server(s) 112 may randomize the time at which a response including the requested content segment(s) are sent to each of the plurality of client devices 104a-n. In addition to the server(s) 112 sending, to each of the plurality of client devices 104a-n, a different, randomly selected quantity of content segments without the plurality of client devices 104a-n requesting the different, randomly selected quantity of content segments, the server(s) 112 may randomize the time at which a response including the randomly selected quantity of content segments are sent to each of the plurality of client devices 104a-n. The system 100 may switch back and forth between the different approaches for reducing the load on the server described above. The system 100 may switch back and forth between the different approaches based on a volume of requests, network conditions, and/or the like.

Each of the plurality of client devices 104a-n may be at least one of a mobile device, a smartphone, a computer, a laptop, a tablet computer, a portable gaming device, a wearable computing device, a set-top box, a streaming video player, a television, a desktop computer, or any other device capable of presenting content to a user. Each of the plurality of client devices 104a-n may comprise any combination of a hardware element, such as a set-top cable box, or a software element, such as a web browser or other software adapted to playback video. Each of the plurality of client devices 104a-n may comprise the interface (e.g., display) 106 for displaying content to a user of the client device 104a-n. It is understood that the interface 106 may be part of a client device, such as in the example that the client device is a tablet, or may be located externally to the client device, such as in the example that the client device is a set-top box and the interface 106 is a television set connected to the set-top box.

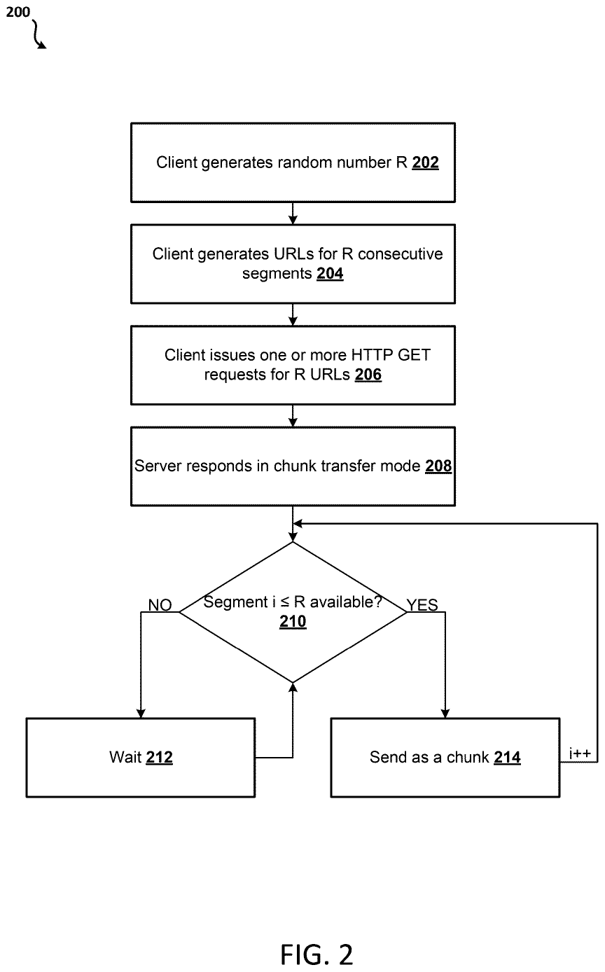

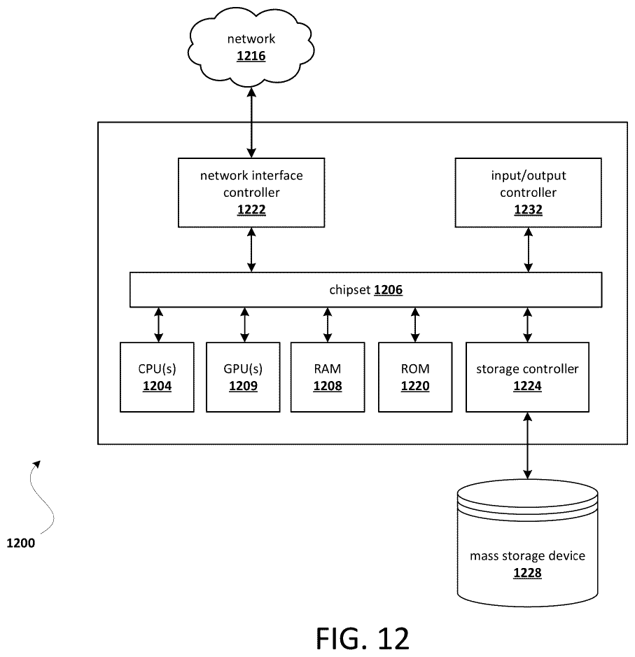

FIG. 2 shows an example method 200. The method 200 may comprise a computer implemented method for reducing server load. A system and/or computing environment, such as the system 100 of FIG. 1 and/or the computing environment of FIG. 12, may be configured to perform the method 200. For example, the client device 104a and the server(s) 112 of FIG. 1 may be configured to perform the method 200.

At 202, a client device may generate a random number R. To determine the random number R, the client device may select a random number R from a predetermined range of quantities. The predetermined range of quantities may be indicated by a manifest associated with a content item or indicated by HTTP headers. The manifest or HTTP headers may be received by the client device. The client device may select the random number R from the predetermined range of quantities using a random pseudo-number generator and a given seed value for the random pseudo-number generator. The seed value may be indicated by the manifest or HTTP headers received by the client device.

At 204, the client device may generate URLs for R consecutive segments of a content item. The client device may generate the URLs for the R consecutive segments based on the manifest associated with the content item. The manifest may contain network location information associated with each segment of the content item. The network location information associated with a particular segment may indicate a future network location associated with the segment, even if the segment has not yet been created. The network location information may comprise, for example, the URL associated with the segment. For example, the manifest may contain a predictive template (e.g., using the SegmentTemplate@duration or S@r=−1). The predictive template may contain the data indicating the network location information for each segment.

At 206, the client device may issue one or more requests (e.g., HTTP GET requests) for the R URLs. The request(s) may comprise a single request. To generate the single request, the client device may build, based on the predictive template contained in the manifest, a list or table of tuples [(t(i), URI(i)], where i ranges from 1 to R, where uniform resource indicator (URI) is the URI (e.g., HTTP(S) URL) of the requested i-th media segment or partial media segment, and t is the deadline by which the corresponding client device needs to receive that segment for successful output. The client device may apply lossless compression (e.g., Brotli) to the list or table of tuples. The client device generate the single request based on the compressed list or table of tuples. The client device may send the single request to one or more servers. The request(s) may comprise a plurality of requests. Each of the plurality of requests may comprise a request for an individual URL among the R URLs.

At 208, the server(s) may respond in chunk transfer mode. The server(s) may individually send the R consecutive segments to the client device (e.g., as separate HTTP responses) as the segments become available. At 210, the server(s) may determine if a segment i is available (e.g., has been created or is otherwise accessible to the server(s)), where i is less than or equal to R. If the segment i is not available, the method 200 may proceed to 212. At 212, the server(s) may wait for the segment i to become available. The method 200 may return to 210 and continue to check if the segment i has become available. If the segment i is available, the method 200 may proceed to 214. At 214, the server(s) may send the segment i to the client device as a HTTP chunk. Based on sending the segment i to the client device as a HTTP chunk, the method 200 may return to 210, and determine if the segment i+1 is available. This process may be repeated until all R segments have been sent to the client device.

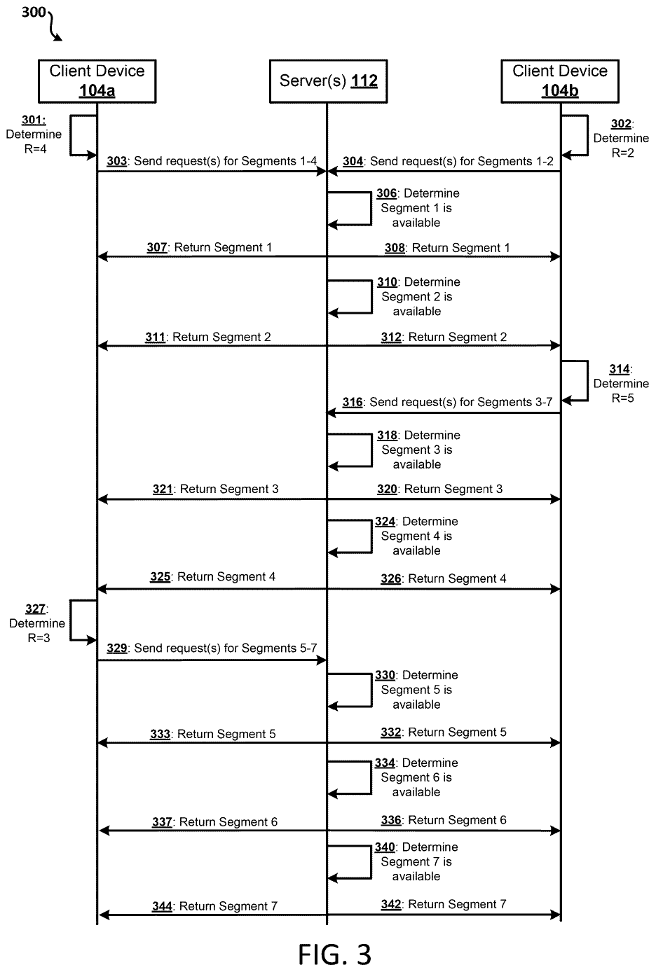

FIG. 3 shows an example method 300. The method 300 may comprise a computer implemented method for reducing server load. A system and/or computing environment, such as the system 100 of FIG. 1 and/or the computing environment of FIG. 12, may be configured to perform the method 300.

A first user associated with the client device 104a and a second user associated with the client device 104b may both want to view (e.g., live stream) the same content item at the same time. The client device 104a and the client device 104b may each determine a random number R of segments of the content item to request from the server(s) 112. To determine the random number R, the client devices 104a-n may each select a random number R from a predetermined range of quantities (e.g., a range indicated by a manifest associated with a content item or indicated by HTTP headers). The client device 104a and the client device 104b may each select the random number R from the predetermined range of quantities using a random pseudo-number generator and a given seed value for the random pseudo-number generator. At 301, the client device 104a may determine R=4. At 302, the client device 104b may determine R=2.

The client device 104a and the client device 104b may each issue one or more requests (e.g., HTTP GET requests) to the server(s) 112 for the R segments. For example, at 303, the client device 104a may send one or more requests for the four nearest segments of the content item (e.g., Segments 1-4). At 304, the client device 104b may send one or more requests for the two nearest segments of the content item (e.g., Segments 1-2). The server(s) 112 may receive these initial request(s) from the client device 104a and the client device 104b at approximately the same time (e.g., simultaneously).

The server(s) 112 may individually send the R consecutive segments to the respective client device (e.g., as separate HTTP responses) as the segments become available. At 306, the server(s) 112 may determine that Segment 1 is available. Based on determining that Segment 1 is available, the server(s) 112 may send Segment 1 to both the client device 104a (at step 307) and the client device 104b (at step 308). Similarly, at 310, the server(s) 112 may determine that Segment 2 is available. Based on determining that Segment 2 is available, the server(s) 112 may send Segment 2 to both the client device 104a (at step 311) and the client device 104b (at step 312).

Based on receiving Segment 2, the client device 104b (but not the client device 104a) may determine that it has received all requested segments from the server(s) 112. Based on the client device 104b determining that it has received all requested segments (e.g., Segments 1-2), the client device 104b may generate a new request for additional segments of the content item. To generate the new request, the client device 104b may once again select a random number R from the predetermined range of quantities (e.g., a range indicated by a manifest associated with a content item or indicated by HTTP headers). At 314, the client device 104b may determine R=5. The client device 104b may issue one or more requests (e.g., HTTP GET requests) to the server(s) 112 for the R segments. For example, at 316, the client device 104b may send one or more requests for next five segments of the content item (e.g., Segments 3-7) to the server(s) 112.

The server(s) 112 may receive the request for Segments 3-7 from the client device 104b at a first time. Because the client device 104a has not yet received all of the initially requested segments (i.e., Segments 1-4), the client device 104a has not yet generated a new request for additional segments of the content item. As such, the server(s) 112 may not receive a request from the client device 104a at the first time. By limiting the quantity of requests that the server(s) 112 receive at the first time, the load on the server(s) 112 is reduced.

The server(s) 112 may continue to send the requested segments to the respective client device (e.g., as separate HTTP responses) as the segments become available. At 318, the server(s) 112 may determine that Segment 3 is available. Based on determining that Segment 3 is available, the server(s) 112 may send Segment 3 to both the client device 104a (at step 321) and the client device 104b (at step 320). Similarly, at 324, the server(s) 112 may determine that Segment 4 is available. Based on determining that Segment 4 is available, the server(s) 112 may send Segment 4 to both the client device 104a (at step 325) and the client device 104b (at step 326).

Based on receiving Segment 4, the client device 104a (but not the client device 104b) may determine that it has received all requested segments from the server(s) 112. Based on the client device 104a determining that it has received all requested segments (e.g., Segments 1-4), the client device 104a may generate a new request for additional segments of the content item. To generate the new request, the client device 104a may once again select a random number R from the predetermined range of quantities (e.g., a range indicated by a manifest associated with a content item or indicated by HTTP headers). At 327, the client device 104a may determine R=3. The client device 104a may issue one or more requests (e.g., HTTP GET requests) to the server(s) 112 for the R segments. For example, at 329, the client device 104a may send one or more requests for next three segments of the content item (e.g., Segments 5-7) to the server(s) 112.

The server(s) 112 may receive the request for Segments 5-7 from the client device 104a at a second time. The second time may occur after the first time. Because the client device 104b has not yet received all of the initially requested segments (i.e., Segments 3-7), the client device 104b has not yet generated a new request for additional segments of the content item. As such, the server(s) 112 may not receive a request from the client device 104b at the second time. By limiting the quantity of requests that the server(s) 112 receive at the second time, the load on the server(s) 112 is reduced.

The server(s) 112 may continue to send the requested segments to the respective client device (e.g., as separate HTTP responses) as the segments become available. At 330, the server(s) 112 may determine that Segment 5 is available. Based on determining that Segment 5 is available, the server(s) 112 may send Segment 5 to both the client device 104a (at step 333) and the client device 104b (at step 332). At 334, the server(s) 112 may determine that Segment 6 is available. Based on determining that Segment 6 is available, the server(s) 112 may send Segment 6 to both the client device 104a (at step 337) and the client device 104b (at step 336). Similarly, at 340, the server(s) 112 may determine that Segment 7 is available. Based on determining that Segment 7 is available, the server(s) 112 may send Segment 7 to both the client device 104a (at step 344) and the client device 104b (at step 342).

Based on receiving Segment 7, the client device 104a and the client device 104b may both determine all requested segments have been received from the server(s) 112. Based on determining that all requested segments have been received, the client devices 104a-b may each generate and send a new request for a random number R of additional segments to the server(s) 112. This process may be repeated until output of the content item is terminated, a requested segment is unavailable, or one of the client devices 104a-b terminates the connection with the server(s) 112. In this manner, requests for segments are spread more evenly over time such that large spikes in requests for a same segment are avoided.

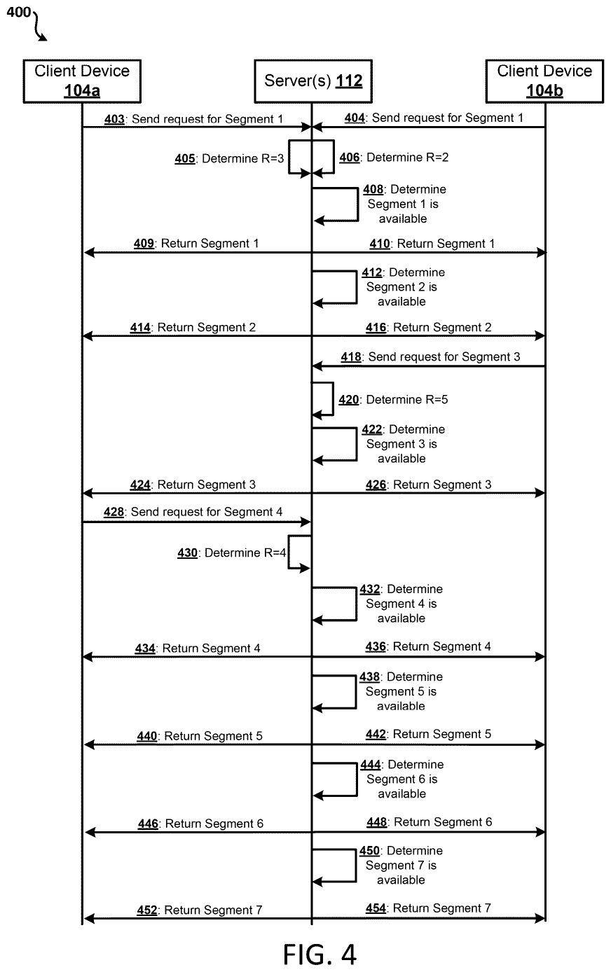

As described above, instead of the plurality of client devices 104a-n requesting a different, randomly selected quantity of content segments from the server(s) 112, the server(s) 112 may send, to each of the plurality of client devices 104a-n, a different, randomly selected quantity of content segments without the plurality of client devices 104a-n requesting the different, randomly selected quantity of content segments. FIG. 4 shows an example method 400. The method 400 may comprise a computer implemented method for reducing server load. A system and/or computing environment, such as the system 100 of FIG. 1 and/or the computing environment of FIG. 12, may be configured to perform the method 400.

A first user associated with the client device 104a and a second user associated with the client device 104b may both want to view (e.g., live stream) the same content item at the same time. At 403, the client device 104a may send a request (e.g., a HTTP GET request) for Segment 1 of the content item to the server(s) 112. Similarly, at 404, the client device 104b may send a request (e.g., HTTP GET request) for Segment 1 of the content item to the server(s) 112. The server(s) 112 may receive the request for Segment 1 from both the client device 104a and the client device 104b at approximately the same time (e.g., simultaneously). Based on (e.g., in response to) receiving the request for Segment 1 from both the client device 104a and the client device 104b, the server(s) 112 may determine a first random number R of segments of the content item to send to the client device 104a and a second random number R of segments of the content item to send to the client device 104b. At 405, the server(s) 112 may determine a first random number R of segments of the content item to send to the client device 104a. For example, the server(s) 112 may determine that R=3 for the client device 104a. At 406, the server(s) 112 may determine a second random number R of segments of the content item to send to the client device 104b. For example, the server(s) 112 may determine that R=2 for the client device 104b.

The server(s) 112 may individually send the R segments to the respective client device (e.g., as separate HTTP responses) as the segments become available. At 408, the server(s) 112 may determine that Segment 1 is available. Based on determining that Segment 1 is available, the server(s) 112 may send Segment 1 to both the client device 104a (at step 409) and the client device 104b (at step 410). The server(s) 112 may send Segment 1 to the client device 104a and to the client device 104b at approximately the same time (e.g., simultaneously). Similarly, at 412, the server(s) 112 may determine that Segment 2 is available. Based on determining that Segment 2 is available, the server(s) 112 may send Segment 2 to both the client device 104a (at step 414) and the client device 104b (at step 416). Based on sending Segment 2 to the client device 104b, the server(s) 112 may send an indication to the client device 104b (but not the client device 104a) that the transfer is complete and/or that the client device 104b should initiate a new request for the next segment.

Based on receiving Segment 2 and/or the indication, the client device 104b (but not the client device 104a) may generate a new request for the next segment of the content item. For example, at 418, the client device 104b may send a request for Segment 3 to the server(s) 112. The server(s) 112 may receive the request for Segment 3 from the client device 104b at a first time. Because the client device 104a has not yet received all of the R segments (i.e., Segments 1-3), the client device 104a has not yet generated a new request for the next segment of the content item. As such, the server(s) 112 may not receive a request from the client device 104a at the first time. By limiting the quantity of requests that the server(s) 112 receive at the first time, the load on the server(s) 112 is reduced.

Based on (e.g., in response to) receiving the request for Segment 3 from the client device 104b, the server(s) 112 may determine a new random number R of segments of the content item to send to the client device 104b in response to the request for Segment 3. At 420, the server(s) 112 may determine a new random number R of segments of the content item to send to the client device 104b. For example, the server(s) 112 may determine that R=5 for the client device 104b.

The server(s) 112 may continue to send the segments to the respective client device (e.g., as separate HTTP responses) as the segments become available. At 422, the server(s) 112 may determine that Segment 3 is available. Based on determining that Segment 3 is available, the server(s) 112 may send Segment 3 to both the client device 104a (at step 424) and the client device 104b (at step 426). Based on sending Segment 3 to the client device 104a, the server(s) 112 may send an indication to the client device 104a (but not the client device 104b) that the transfer is complete and/or that the client device 104a should initiate a new request for the next segment.

Based on receiving Segment 3 and/or the indication, the client device 104a (but not the client device 104b) may generate a new request for the next segment of the content item. For example, at 428, the client device 104a may send a request for Segment 4 to the server(s) 112. The server(s) 112 may receive the request for Segment 4 from the client device 104a at a second time. Because the client device 104a has not yet received all of the R segments (i.e., Segments 3-7), the client device 104b has not yet generated a new request for the next segment of the content item. As such, the server(s) 112 may not receive a request from the client device 104b at the second time. By limiting the quantity of requests that the server(s) 112 receive at the second time, the load on the server(s) 112 is reduced.

Based on (e.g., in response to) receiving the request for Segment 4 from the client device 104a, the server(s) 112 may determine a new random number R of segments of the content item to send to the client device 104a in response to the request for Segment 4. At 430, the server(s) 112 may determine a new random number R of segments of the content item to send to the client device 104a. For example, the server(s) 112 may determine that R=4 for the client device 104a.

The server(s) 112 may continue to send the segments to the respective client device (e.g., as separate HTTP responses) as the segments become available. At 432, the server(s) 112 may determine that Segment 4 is available. Based on determining that Segment 4 is available, the server(s) 112 may send Segment 4 to both the client device 104a (at step 434) and the client device 104b (at step 436). Similarly, at 438, the server(s) 112 may determine that Segment 5 is available. Based on determining that Segment 5 is available, the server(s) 112 may send Segment 5 to both the client device 104a (at step 440) and the client device 104b (at step 442). At 444, the server(s) 112 may determine that Segment 6 is available. Based on determining that Segment 6 is available, the server(s) 112 may send Segment 6 to both the client device 104a (at step 446) and the client device 104b (at step 448). At 450, the server(s) 112 may determine that Segment 7 is available. Based on determining that Segment 7 is available, the server(s) 112 may send Segment 7 to both the client device 104a (at step 452) and the client device 104b (at step 454).

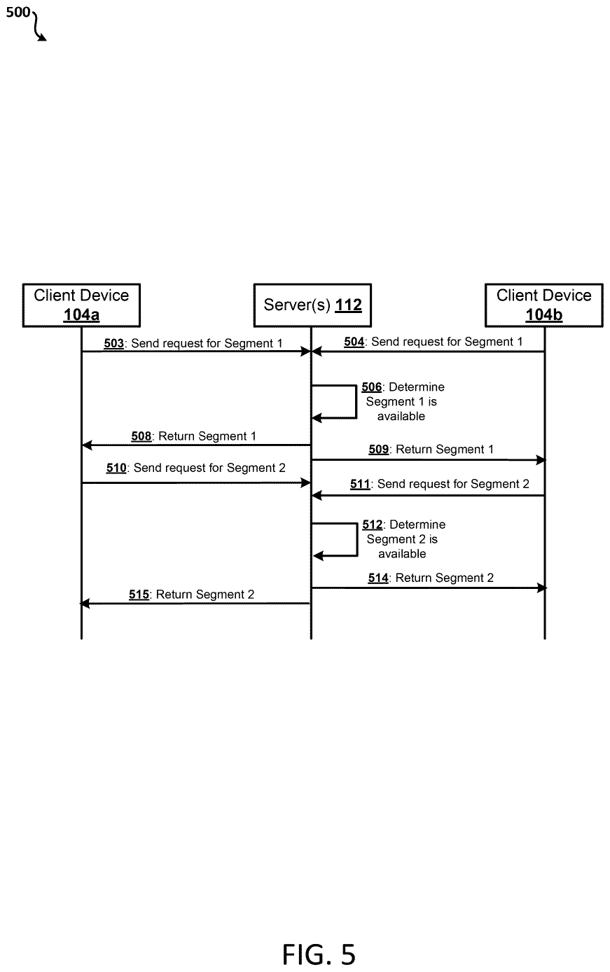

As described above, if the server(s) 112 receive a request for a segment of a content item from each of the plurality of client devices 104a-n, instead of simultaneously sending a response including the segment to each of the plurality of client devices 104a-n, the server(s) 112 may send a response including the segment to each of the plurality of client devices 104a-n at a different time. FIG. 5 shows an example method 500. The method 500 may comprise a computer implemented method for reducing server load. A system and/or computing environment, such as the system 100 of FIG. 1 and/or the computing environment of FIG. 12, may be configured to perform the method 500.

A first user associated with the client device 104a and a second user associated with the client device 104b may both want to view (e.g., live stream) the same content item at the same time. At 503, the client device 104a may send a request (e.g., a HTTP GET request) for Segment 1 of the content item to the server(s) 112. Similarly, at 504, the client device 104b may send a request (e.g., HTTP GET request) for Segment 1 of the content item to the server(s) 112. The server(s) 112 may receive the request for Segment 1 from both the client device 104a and the client device 104b at approximately the same time (e.g., simultaneously).

Based on (e.g., in response to) receiving the request for Segment 1 from both the client device 104a and the client device 104b, the server(s) 112 may determine a first time at which to send Segment 1 to the client device 104a and a second time at which to send Segment 1 to the client device 104b. The first time and the second time may both occur within a predetermined time window (e.g., 2 seconds, 3 seconds, etc.) The first time may occur before the second time. For example, the first time may occur 0.2 seconds, 0.5 seconds, one second, or any other amount of time before the second time. At 506, the server(s) 112 may determine that Segment 1 is available. At 508, the server(s) 112 may send Segment 1 to the client device 104a at the first time based on determining that Segment 1 is available. At 509, the server(s) 112 may send Segment 1 to the client device 104b at the second time based on determining that Segment 1 is available.

Based on receiving Segment 1, the client device 104a may generate a new request for the next segment (e.g., Segment 2) of the content item. For example, at 510, the client device 104a may send a request for Segment 2 to the server(s) 112. Similarly, based on receiving Segment 1, the client device 104b may generate a new request for the next segment (e.g., Segment 2) of the content item. For example, at 511, the client device 104b may send a request for Segment 2 to the server(s) 112. Because the client device 104a received Segment 1 before client device 104b received Segment 1, client device 104a may send the request for Segment 2 to the server(s) 112 before the client device 104b sends the request for Segment 2 to the server(s) 112. As such, the server(s) 112 may receive the request for Segment 2 from the client device 104a before receiving the request for Segment 3 from the client device 104b, thereby limiting the quantity of requests that the server(s) 112 receives one time.

Based on (e.g., in response to) receiving the request for Segment 2 from both the client device 104a and the client device 104b, the server(s) 112 may determine a third time at which to send Segment 1 to the client device 104a and a fourth time at which to send Segment 2 to the client device 104b. The third time and the fourth time may both occur within the predetermined time window (e.g., 2 seconds, 3 seconds, etc.) The third time may occur after the fourth time. For example, the third time may occur 0.2 seconds, 0.5 seconds, one second, or any other amount of time after the fourth time. At 512, the server(s) 112 may determine that Segment 2 is available.

At 514, the server(s) 112 may send Segment 2 to the client device 104b at the fourth time based on determining that Segment 2 is available. At 515, the server(s) 112 may send Segment 2 to the client device 104a at the third time based on determining that Segment 2 is available. Because the client device 104b received Segment 2 before client device 104a received Segment 2, client device 104b may send the request for the next segment (e.g., Segment 3) to the server(s) 112 before the client device 104a sends the request for Segment 3 to the server(s) 112. As such, the server(s) 112 may receive the request for Segment 3 from the client device 104b before receiving the request for Segment 3 from the client device 104a, thereby limiting the quantity of requests that the server(s) 112 receives one time. The above process may be repeated until output of the content item is terminated, a requested segment is unavailable, or the client device terminates the connection with the server(s) 112.

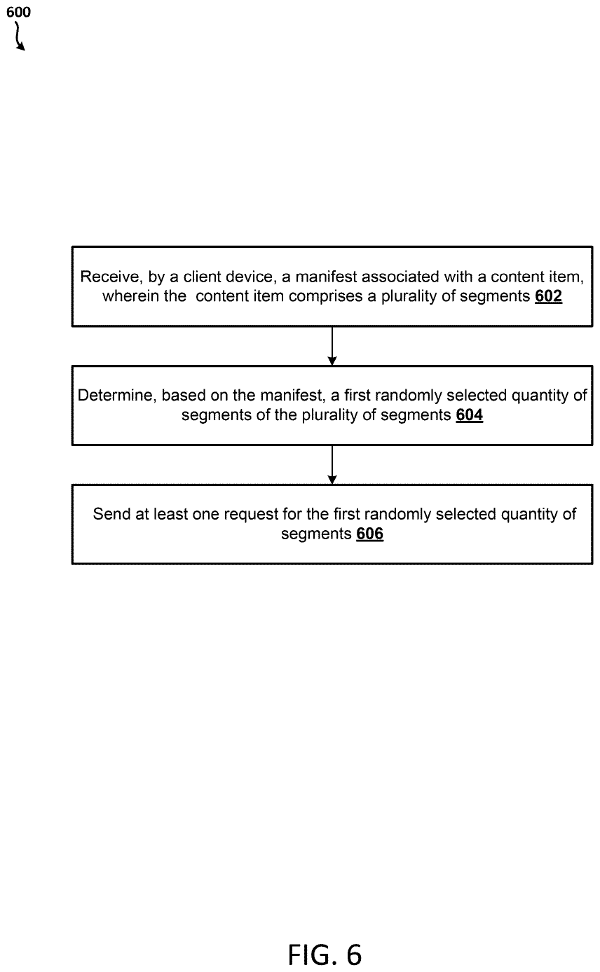

FIG. 6 shows an example method 600. The method 600 may comprise a computer implemented method for reducing server load. A system and/or computing environment, such as the system 100 of FIG. 1 and/or the computing environment of FIG. 12, may be configured to perform the method 600. For example, any of the plurality of client devices 104a-n of FIG. 1 may be configured to perform the method 600.

At 602, a manifest associated with a content item may be received. The content item may comprise a plurality of segments. The manifest may comprise a media presentation description (MPD) (e.g., a MPEG-DASH manifest file). The manifest may contain information describing various aspects of each segment of the content item that may be useful for causing output (e.g., playback) of the content item. The manifest may data indicating the length (e.g., size, duration) of the segments of the content item. The manifest may contain network location information associated with each segment of the content item. The network location information associated with a particular segment may indicate a future network location associated with the segment, even if the segment has not yet been created. The network location information may comprise, for example, a uniform resource locator (URL) associated with the segment. The manifest may contain information indicating a range of quantities. The range of quantities may indicate a number of segments of the content item that may be requested at one time. The range of quantities of segments may be determined based at least in part on the length (e.g., size, duration) of the segments of the content item.

At 604, a first randomly selected quantity of segments of the plurality of segments may be determined. The first randomly selected quantity of segments may be determined based on the manifest. To determine the first randomly selected quantity of segments, a random number R may be selected from the range of quantities indicated by the manifest. The random number R may indicate the quantity of segments in the first randomly selected quantity of segments. The network location information, such as a URL, associated with each of the R segments in the first randomly selected quantity of segments may be determined. For example, the network location information associated with each of the R segments in the first randomly selected quantity of segments may be determined based on the manifest. For example, the network location information associated with each of the R segments in the first randomly selected quantity of segments may be determined based on a predictive template provided in the manifest.

At 606, at least one request for the first randomly selected quantity of segments may be sent. The at least one request may be sent to one or more servers. Sending the at least one request for the first randomly selected quantity of segments may comprise sending a single request for the first randomly selected quantity of segments. Sending the at least one request for the first randomly selected quantity of segments may comprise sending a plurality of requests. Each of the plurality of requests may comprise a request for an individual segment among the first randomly selected quantity of segments.

The requested first randomly selected quantity of segments may be received from the server. Receiving the requested first randomly selected quantity of segments may comprise individually receiving, from the server, each segment among the first randomly selected quantity of segments. Individually receiving each segment among the first randomly selected quantity of segments may comprise receiving, at a first time and based on a first segment among the first randomly selected quantity of segments becoming available to the server, the first segment. Individually receiving each segment among the first randomly selected quantity of segments may comprise receiving, at a second time and based on a second segment among the first randomly selected quantity of segments becoming available to the server, the second segment. The second time may occur after the first time. Output (e.g., display, playback) of the received segments among the first randomly selected quantity of segments may be caused.

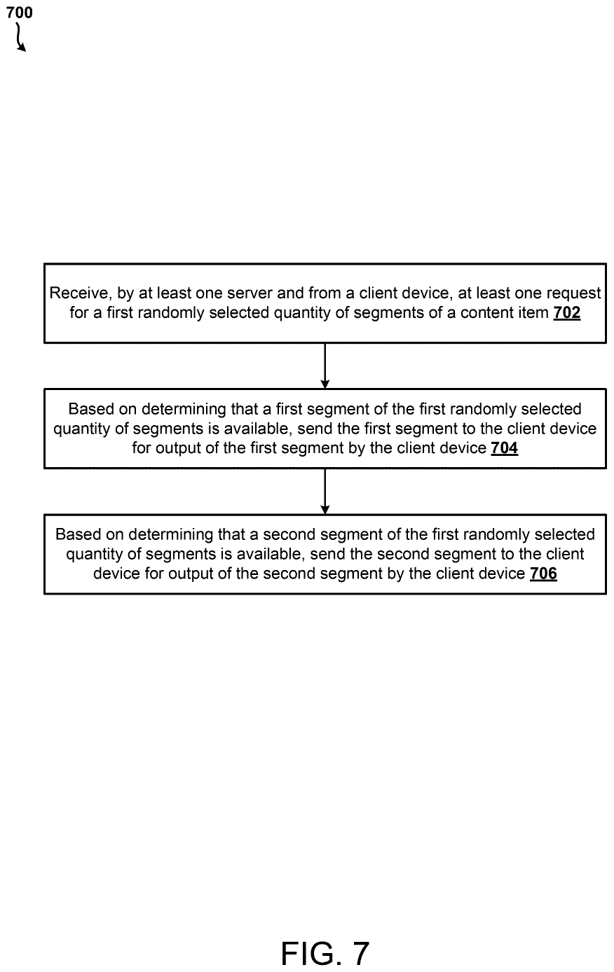

FIG. 7 shows an example method 700. The method 700 may comprise a computer implemented method for reducing server load. A system and/or computing environment, such as the system 100 of FIG. 1 and/or the computing environment of FIG. 12, may be configured to perform the method 700. For example, the server device(s) 112 of FIG. 1 may be configured to perform the method 700.

At 702, at least one request for a first randomly selected quantity of segments of a content item may be received. The at least one request may be received from a client device. The at least one request may comprise a single request for the first randomly selected quantity of segments. The at least one request may comprise a plurality of requests. Each of the plurality of requests may comprise a request for an individual segment among the first randomly selected quantity of segments. The at least one request for the first randomly selected quantity of segments may comprise network location information, such as a URL, associated with each segment in the first randomly selected quantity of segments. The client device may be configured to determine the first randomly selected quantity of segments based on a manifest associated with the content item.

At 704, a first segment of the first randomly selected quantity of segments may be sent to the client device. The first segment of the first randomly selected quantity of segments may be sent to the client device based on determining that the first segment is available. Determining that the first segment is available may comprise determining that the first segment has been created or is otherwise available to the server(s). Sending the first segment of the first randomly selected quantity of segments to the client device may cause output (e.g., display, playback) of the first segment by the client device. The first segment may be sent to the client device at a first time.

At 706, a second segment of the first randomly selected quantity of segments may be sent to the client device. The second segment of the first randomly selected quantity of segments may be sent to the client device based on determining that the second segment is available. Determining that the second segment is available may comprise determining that the second segment has been created or is otherwise available to the server(s). Sending the second segment of the first randomly selected quantity of segments to the client device may cause output (e.g., display, playback) of the second segment by the client device. The second segment may be sent to the client device at a second time. The second time may occur after the first time.

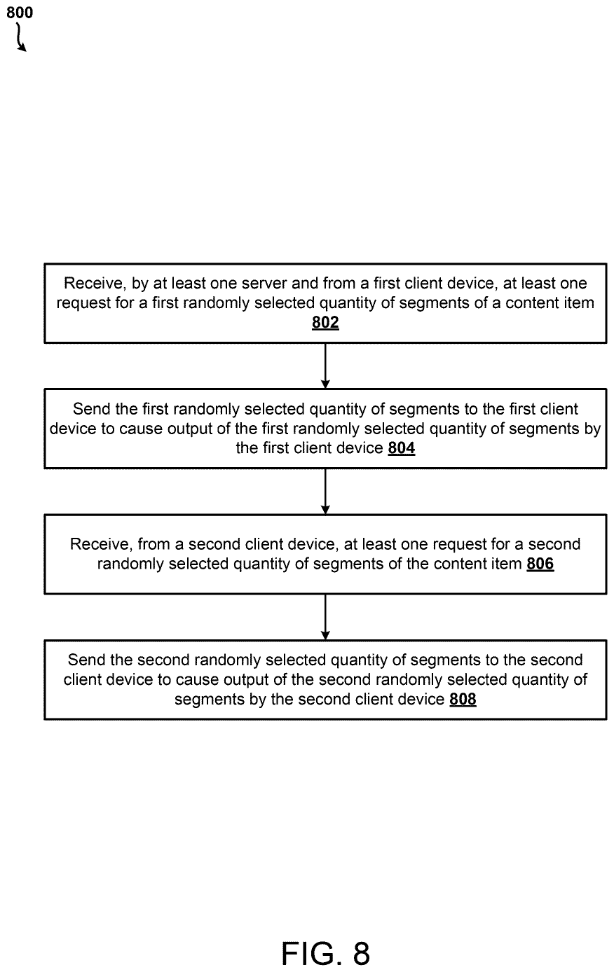

FIG. 8 shows an example method 800. The method 800 may comprise a computer implemented method for reducing server load. A system and/or computing environment, such as the system 100 of FIG. 1 and/or the computing environment of FIG. 12, may be configured to perform the method 800. For example, the server device(s) 112 of FIG. 1 may be configured to perform the method 800.

At 802, at least one request for a first randomly selected quantity of segments of a content item may be received. The at least one request may be received from a first client device. The at least one request may comprise a single request for the first randomly selected quantity of segments. The at least one request may comprise a plurality of requests. Each of the plurality of requests may comprise a request for an individual segment among the first randomly selected quantity of segments. The at least one request for the first randomly selected quantity of segments may comprise network location information, such as a URL, associated with each segment in the first randomly selected quantity of segments. The first client device may be configured to determine the first randomly selected quantity of segments based on a manifest associated with the content item.

At 804, the first randomly selected quantity of segments may be sent to the first client device. Sending the first randomly selected quantity of segments to the first client device may comprise individually sending each segment among the first randomly selected quantity of segments to the first client device. The segments of the first randomly selected quantity of segments may be sent to the first client device as they become available. Determining that a segment is available may comprise determining that the segment has been created or is otherwise available to the server(s). Sending the first randomly selected quantity of segments to the first client device may cause output (e.g., display, playback) of the first randomly selected quantity of segments by the first client device.

At 806, at least one request for a second randomly selected quantity of segments of a content item may be received. The at least one request may be received from a second client device. The at least one request may comprise a single request for the second randomly selected quantity of segments. The at least one request may comprise a plurality of requests. Each of the plurality of requests may comprise a request for an individual segment among the second randomly selected quantity of segments. The at least one request for the second randomly selected quantity of segments may comprise network location information, such as a URL, associated with each segment in the second randomly selected quantity of segments. The second client device may be configured to determine the second randomly selected quantity of segments based on the manifest associated with the content item.

At 808, the second randomly selected quantity of segments may be sent to the second client device. Sending the second randomly selected quantity of segments to the second client device may comprise individually sending each segment among the second randomly selected quantity of segments to the second client device. The segments of the second randomly selected quantity of segments may be sent to the second client device as they become available. Determining that a segment is available may comprise determining that the segment has been created or is otherwise available to the server(s). Sending the second randomly selected quantity of segments to the second client device may cause output (e.g., display, playback) of the second randomly selected quantity of segments by the second client device.

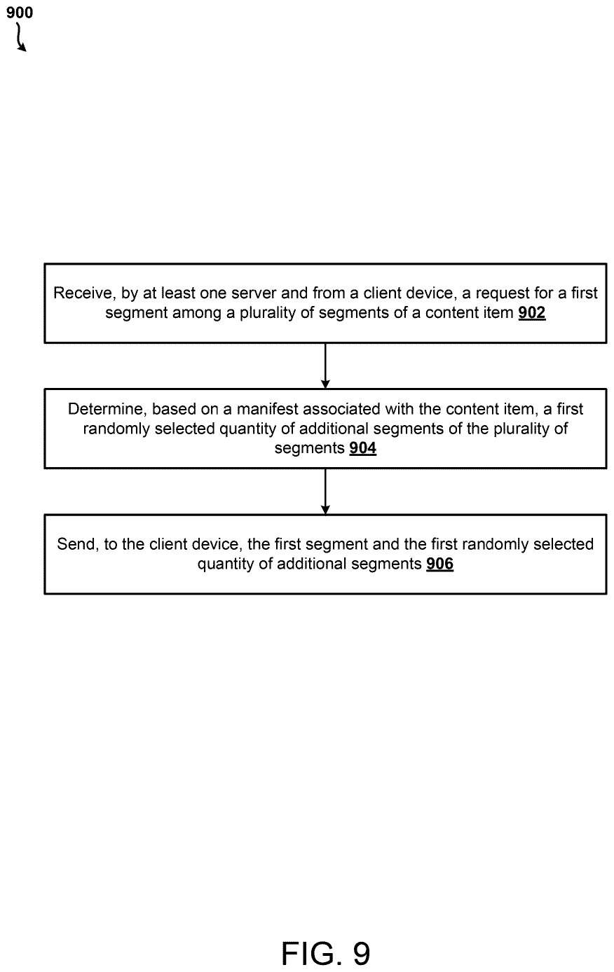

FIG. 9 shows an example method 900. The method 900 may comprise a computer implemented method for reducing server load. A system and/or computing environment, such as the system 100 of FIG. 1 and/or the computing environment of FIG. 12, may be configured to perform the method 900. For example, the server device(s) 112 of FIG. 1 may be configured to perform the method 900.

At 902, a request for a first segment of a content item may be received. The request may be received from a client device. The request may comprise a single request for the first segment. The request for the first segment may comprise network location information, such as a URL, associated with the first segment. The client device may be configured to generate the request for the first segment based on a manifest associated with the content item.

At 904, a first randomly selected quantity of additional segments (e.g., segments of the content item in addition to the first segment) may be determined. The first randomly selected quantity of additional segments may be determined based on the manifest. To determine the first randomly selected quantity of additional segments, a random number R may be selected from a range of quantities indicated by the manifest. The random number R may indicate the quantity of segments in the first randomly selected quantity of additional segments. The network location information, such as a URL, associated with each of the R segments in the first randomly selected quantity of additional segments may be determined. For example, the network location information associated with each of the R segments in the first randomly selected quantity of additional segments may be determined based on the manifest. The first segment and the first randomly selected quantity of additional segments may comprise consecutive segments among the plurality of segments. For example, the first randomly selected quantity of additional segments may comprise the R segments immediately following the first segment.

At 906, the first segment and the first randomly selected quantity of additional segments may be sent. The first segment and the first randomly selected quantity of additional segments may be sent to the client device. Sending, to the client device, the first segment and the first randomly selected quantity of additional segments may comprise individually sending the first segment and each of the first randomly selected quantity of additional segments. Individually sending the first segment and each of the first randomly selected quantity of additional segments may comprise sending, at a first time and based on the first segment becoming available to the at least one server, the first segment. Individually sending the first segment and each of the first randomly selected quantity of additional segments may further comprise sending, at a second time and based on a second segment among the first randomly selected quantity of additional segments becoming available to the at least one server, the second segment. The second time may occur after the first time.

Based on sending the first segment and each of the first randomly selected quantity of additional segments to the client device, a message may be sent to the client device. The message may indicate to the client device that the at least one server has completed the transfer of the first segment and the first randomly selected quantity of additional segments and/or may instruct the client device to initiate a new request for the segment immediately following the last segment in the first randomly selected quantity of additional segments (e.g., the next segment). If the client device uses HTTP/1.1, the message may comprise a zero-byte response that signals to the client device that the transfer is complete and/or that instructs the client device to initiate a new request for the next segment. If the client device uses HTTP/2.0 or HTTP/3.0, the message may comprise a “go away” signal that signals to the client device that the transfer is complete and/or that instructs the client device to initiate a new request for the next segment.

Based on sending the message, a request for a second segment among the plurality of segments of the content item may be received. The second segment may comprise the next segment among the plurality of segments. Based on receiving the request for the second segment, a second randomly selected quantity of additional segments (e.g., segments of the content item in addition to the second segment) may be determined.

The second randomly selected quantity of additional segments may be determined based on the manifest. To determine the second randomly selected quantity of additional segments, a random number R may be selected from a range of quantities indicated by the manifest. The random number R may indicate the quantity of segments in the second randomly selected quantity of additional segments. The network location information, such as a URL, associated with each of the R segments in the second randomly selected quantity of additional segments may be determined. For example, the network location information associated with each of the R segments in the second randomly selected quantity of additional segments may be determined based on the manifest. The second randomly selected quantity of additional segments may be different from (e.g., comprise a different quantity of segments than) the first randomly selected quantity of additional segments. The second segment and the second randomly selected quantity of additional segments may comprise consecutive segments among the plurality of segments. For example, the second randomly selected quantity of additional segments may comprise the R segments immediately following the second segment. The second segment and the second randomly selected quantity of additional segments may be sent to the client device.

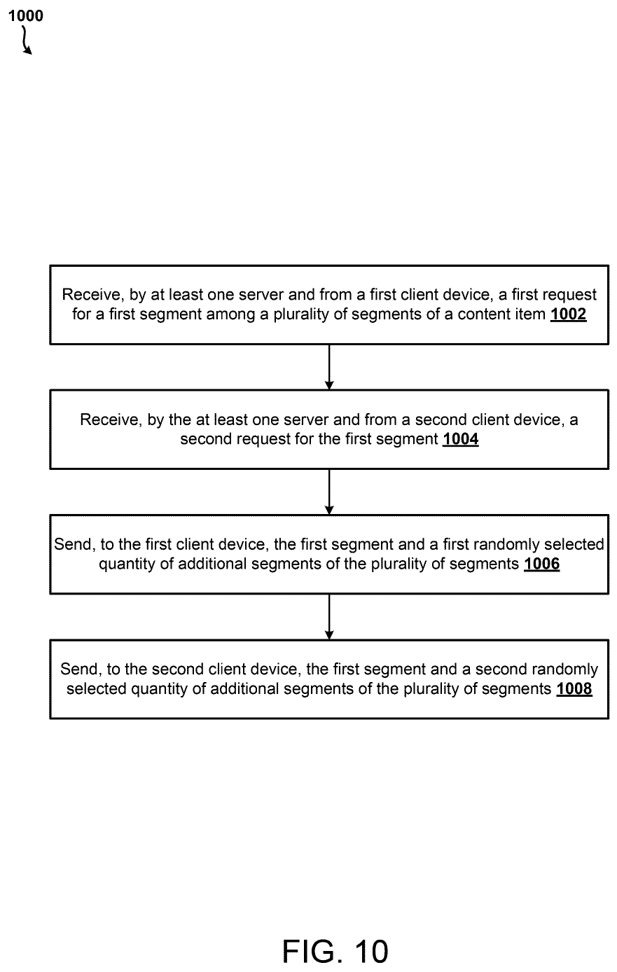

FIG. 10 shows an example method 1000. The method 1000 may comprise a computer implemented method for reducing server load. A system and/or computing environment, such as the system 100 of FIG. 1 and/or the computing environment of FIG. 12, may be configured to perform the method 1000. For example, the server device(s) 112 of FIG. 1 may be configured to perform the method 1000.

At 1002, a first request for a first segment of a content item may be received. The first request may be received from a first client device. The first request may comprise a single request for the first segment. The first request for the first segment may comprise network location information, such as a URL, associated with the first segment. The first client device may be configured to generate the first request for the first segment based on a manifest associated with the content item.

At 1004, a second request for a first segment of a content item may be received. The second request may be received from a second client device. The second request may comprise a single request for the first segment. The second request for the first segment may comprise network location information, such as a URL, associated with the first segment. The second client device may be configured to generate the second request for the first segment based on a manifest associated with the content item.

At 1006, the first segment and a first randomly selected quantity of additional segments of the plurality of segments (e.g., segments of the content item in addition to the first segment) may be sent to the first client device. The first segment and the first randomly selected quantity of additional segments may comprise consecutive segments among the plurality of segments. For example, the first randomly selected quantity of additional segments may comprise the R segments immediately following the first segment, where R has a first value. Sending, to the first client device, the first segment and the first randomly selected quantity of additional segments may comprise individually sending the first segment and each of the first randomly selected quantity of additional segments (e.g., as they become available to the at least one server).

Based on sending the first segment and each of the first randomly selected quantity of additional segments to the client device, a first message may be sent to the first client device. The first message may indicate to the first client device that the at least one server has completed the transfer of the first segment and the first randomly selected quantity of additional segments and/or may instruct the first client device to initiate a new request for the segment immediately following the last segment in the first randomly selected quantity of additional segments (e.g., the next segment). If the first client device uses HTTP/1.1, the first message may comprise a zero-byte response that signals to the first client device that the transfer is complete and/or that instructs the first client device to initiate a new request for the next segment. If the first client device uses HTTP/2.0 or HTTP/3.0, the first message may comprise a “go away” signal that signals to the first client device that the transfer is complete and/or that instructs the first client device to initiate a new request for the next segment. Based on sending the first message, a request for a second segment among the plurality of segments of the content item may be received from the first client device. The request for a second segment among the plurality of segments of the content item may be received from the first client device at a first time.

At 1008, the first segment and a second randomly selected quantity of additional segments of the plurality of segments (e.g., segments of the content item in addition to the first segment) may be sent to the second client device. The second randomly selected quantity of additional segments may be different from (e.g., comprise a different quantity of segments than) the first randomly selected quantity of additional segments. The first segment and the first randomly selected quantity of additional segments may comprise consecutive segments among the plurality of segments. For example, the first randomly selected quantity of additional segments may comprise the R segments immediately following the first segment, where R has a second value. The second value may be different from the first value. Sending, to the second client device, the first segment and the second randomly selected quantity of additional segments may comprise individually sending the first segment and each of the second randomly selected quantity of additional segments (e.g., as they become available to the at least one server).

Based on sending the first segment and each of the second randomly selected quantity of additional segments to the second client device, a second message may be sent to the second client device. The second message may indicate to the second client device that the at least one server has completed the transfer of the first segment and the second randomly selected quantity of additional segments and/or may instruct the second client device to initiate a new request for the segment immediately following the last segment in the second randomly selected quantity of additional segments (e.g., the next segment). If the second client device uses HTTP/1.1, the second message may comprise a zero-byte response that signals to the second client device that the transfer is complete and/or that instructs the second client device to initiate a new request for the next segment. If the second client device uses HTTP/2.0 or HTTP/3.0, the second message may comprise a “go away” signal that signals to the second client device that the transfer is complete and/or that instructs the second client device to initiate a new request for the next segment. Based on sending the second message, a request for the second segment among the plurality of segments of the content item may be received from the second client device. The request for the second segment among the plurality of segments of the content item may be received from the second client device at a second time. The second time may be different from the first time.

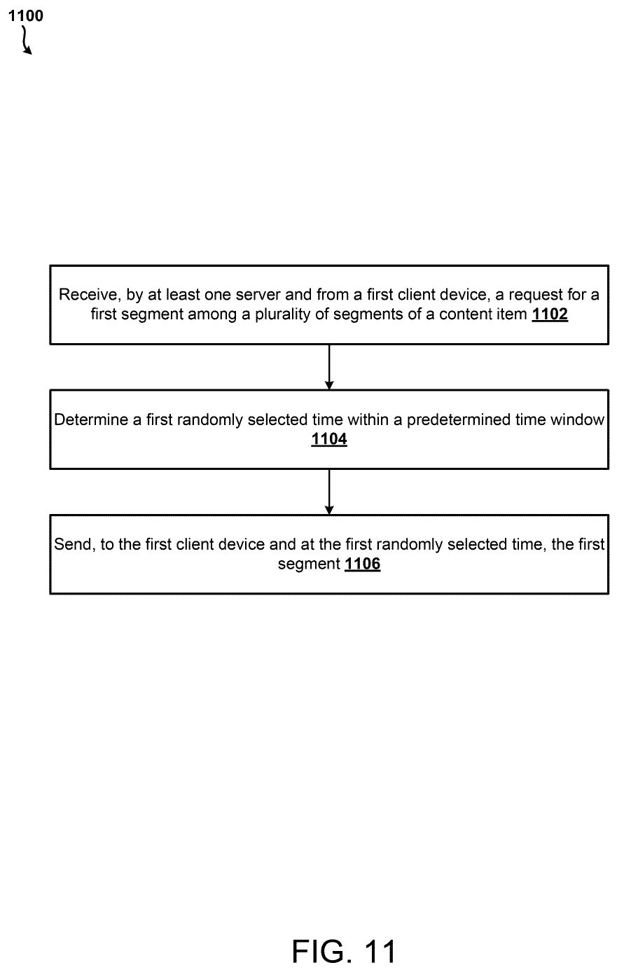

FIG. 11 shows an example method 1100. The method 1100 may comprise a computer implemented method for reducing server load. A system and/or computing environment, such as the system 100 of FIG. 1 and/or the computing environment of FIG. 12, may be configured to perform the method 1100. For example, the server device(s) 112 of FIG. 1 may be configured to perform the method 1100.

At 1102, a request for a first segment of a content item may be received. The request may be received from a first client device. The request may comprise a single request for the first segment. The request for the first segment may comprise network location information, such as a URL, associated with the first segment. The first client device may be configured to generate the request for the first segment based on a manifest associated with the content item.

At 1104, a first randomly selected time may be determined. Determining the first randomly selected time may comprise randomly selecting a time within a predetermined time window. The predetermined window of time may comprise, for example, the prefetching period. The prefetching period may refer to the time period between the first client device requesting the first segment of the content item before the first segment is actually needed for output (e.g., playback). For example, the predetermined time window may comprise a period of time in between the first client device sending the request for the first segment and a scheduled output time associated with the first segment. The predetermined time window may comprise any duration of time, such as one second, two seconds, three seconds, etc. For example, if the predetermined time window comprises a two-second window (e.g., ranging from zero to two seconds), the first randomly selected time may comprise 0.2 seconds, 0.5 seconds, 1 second, etc.

At 1106, the first segment may be sent at the first randomly selected time. The first segment may be sent to the first client device at the first randomly selected time. Based on sending the first segment to the first client device at the first randomly selected time, a request for a second segment among the plurality of segments may be received from the first client device. The request for the second segment among the plurality of segments may be received from the first client device at a first time.

A request for the first segment of a content item may additionally be received from a second client device. A second randomly selected time may be determined. Determining the second randomly selected time may comprise randomly selecting a time within the predetermined time window. The second randomly selected time may be different from the first randomly selected time. For example, if the predetermined time window comprises a two-second window (e.g., ranging from zero to two seconds) and the first randomly selected time is 0.5 seconds, the second randomly selected time may be 0.2 seconds, 1 second, 1.5 seconds, etc.

The first segment may be sent to the second client device at the second randomly selected time. Based on sending the first segment to the second client device at the second randomly selected time, a request for the second segment among the plurality of segments may be received from the second client device. The request for the second segment among the plurality of segments may be received from the second client device at a second time. The second time may be different from (e.g., occur before or after) the first time.

FIG. 12 shows a computing device 1200 that may be used in various aspects, such as one or more of the computing device(s) 102, the plurality of client devices 104a-n, and the server device(s) 112 depicted in FIG. 1. With regard to the example architecture of FIG. 1, any of the servers, devices, or components may each be implemented in an instance of a computing device 1200 of FIG. 12.

The computer architecture shown in FIG. 12 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 2-11.

The computing device 1200 may include a baseboard, or “motherboard,” which is a printed circuit board to which a multitude of components or devices may be connected by way of a system bus or other electrical communication paths. One or more central processing units (CPUs) 1204 may operate in conjunction with a chipset 1206. The CPU(s) 1204 may be standard programmable processors that perform arithmetic and logical operations necessary for the operation of the computing device 1200.

The CPU(s) 1204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1204 may be augmented with or replaced by other processing units, such as GPU(s) 1209. The GPU(s) 1209 may comprise processing units specialized for but not necessarily limited to highly parallel computations, such as graphics and other visualization-related processing.

A chipset 1206 may provide an interface between the CPU(s) 1204 and the remainder of the components and devices on the baseboard. The chipset 1206 may provide an interface to a random access memory (RAM) 1208 used as the main memory in the computing device 1200. The chipset 1206 may further provide an interface to a computer-readable storage medium, such as a read-only memory (ROM) 1220 or non-volatile RAM (NVRAM) (not shown), for storing basic routines that may help to start up the computing device 1200 and to transfer information between the various components and devices. ROM 1220 or NVRAM may also store other software components necessary for the operation of the computing device 1200 in accordance with the aspects described herein.

The computing device 1200 may operate in a networked environment using logical connections to remote computing nodes and computer systems through local area network (LAN) 1216. The chipset 1206 may include functionality for providing network connectivity through a network interface controller (NIC) 1222, such as a gigabit Ethernet adapter. A NIC 1222 may be capable of connecting the computing device 1200 to other computing nodes over a network 1216. It should be appreciated that multiple NICs 1222 may be present in the computing device 1200, connecting the computing device to other types of networks and remote computer systems.

The computing device 1200 may be connected to a mass storage device 1228 that provides non-volatile storage for the computer. The mass storage device 1228 may store system programs, application programs, other program modules, and data, which have been described in greater detail herein. The mass storage device 1228 may be connected to the computing device 1200 through a storage controller 1224 connected to the chipset 1206. The mass storage device 1228 may consist of one or more physical storage units. A storage controller 1224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1200 may store data on a mass storage device 1228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1228 is characterized as primary or secondary storage and the like.

For example, the computing device 1200 may store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 may further read information from the mass storage device 1228 by detecting the physical states or characteristics of one or more particular locations within the physical storage units.

In addition to the mass storage device 1228 described above, the computing device 1200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic citemtes, magnetic tape, magnetic disk storage, other magnetic storage devices, or any other medium that may be used to store the desired information in a non-transitory fashion.

A mass storage device, such as the mass storage device 1228 depicted in FIG. 12, may store an operating system utilized to control the operation of the computing device 1200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1228 may store other system or application programs and data utilized by the computing device 1200.

The mass storage device 1228 or other computer-readable storage media may also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described above. The computing device 1200 may have access to computer-readable storage media storing computer-executable instructions, which, when executed by the computing device 1200, may perform the methods described in relation to FIGS. 2-11.

A computing device, such as the computing device 1200 depicted in FIG. 12, may also include an input/output controller 1232 for receiving and processing input from a number of input devices, such as a keyboard, a mouse, a touchpad, a touch screen, an electronic stylus, or other type of input device. Similarly, an input/output controller 1232 may provide output to a display, such as a computer monitor, a flat-panel display, a digital projector, a printer, a plotter, or other type of output device. It will be appreciated that the computing device 1200 may not include all of the components shown in FIG. 12, may include other components that are not explicitly shown in FIG. 12, or may utilize an architecture completely different than that shown in FIG. 12.

As described herein, a computing device may be a physical computing device, such as the computing device 1200 of FIG. 12. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving, by a client device, a manifest associated with a content item, wherein the content item comprises a plurality of segments;
determining, based on the manifest, a first randomly selected quantity of segments of the plurality of segments; and
sending, to a server, at least one request for the first randomly selected quantity of segments.

2. The method of claim 1, wherein determining, based on the manifest, the first randomly selected quantity of segments comprises:
determining, based on the manifest, a predetermined range of quantities; and
determining the first randomly selected quantity of segments based on randomly selecting a quantity from the predetermined range of quantities.

3. The method of claim 1, wherein determining, based on the manifest, the first randomly selected quantity of segments comprises determining, based on the manifest, network location information associated with each segment in the first randomly selected quantity of segments, and wherein the at least one request for the first randomly selected quantity of segments comprises the network location information associated with each segment in the first randomly selected quantity of segments.

4. The method of claim 3, wherein the manifest indicates a uniform resource locator (URL) associated with each of the plurality of segments, and wherein the network location information associated with each segment in the first randomly selected quantity of segments comprises the URL associated with each segment in the first randomly selected quantity of segments.

5. The method of claim 1, wherein sending, to the server, the at least one request for the first randomly selected quantity of segments comprises sending a single request for the first randomly selected quantity of segments.

6. The method of claim 1, wherein sending, to the server, the at least one request for the first randomly selected quantity of segments comprises sending a plurality of requests to the server, wherein each of the plurality of requests comprises a request for an individual segment of the first randomly selected quantity of segments.

7. The method of claim 1, further comprising:
receiving, from the server, the requested first randomly selected quantity of segments; and
causing output of the first randomly selected quantity of segments.

8. The method of claim 1, wherein receiving, from the server, the requested first randomly selected quantity of segments comprises:
individually receiving, from the server, each segment of the first randomly selected quantity of segments.

9. The method of claim 8, wherein individually receiving, from the server, each segment of the first randomly selected quantity of segments comprises:
receiving, at a first time and based on a first segment of the first randomly selected quantity of segments becoming available to the server, the first segment; and
receiving, at a second time and based on a second segment of the first randomly selected quantity of segments becoming available to the server, the second segment, wherein the second time occurs after the first time.

10. The method of claim 1, further comprising:
based on receiving the first randomly selected quantity of segments from the server, determining a second randomly selected quantity of segments of the plurality of segments, wherein the second randomly selected quantity of segments comprises a different quantity of segments than the first randomly selected quantity of segments; and
causing output of the second randomly selected quantity of segments based on sending, to the server, at least one request for the second randomly selected quantity of segments.

11. A method comprising:
receiving, by at least one server and from a client device, a request for a first segment of a plurality of segments of a content item;
determining, based on a manifest associated with the content item, a first randomly selected quantity of additional segments of the plurality of segments; and
sending, to the client device, the first segment and the first randomly selected quantity of additional segments.

12. The method of claim 11, wherein determining, based on the manifest, the first randomly selected quantity of additional segments comprises:
determining, based on the manifest, a predetermined range of quantities; and
determining the first randomly selected quantity of additional segments based on randomly selecting a quantity from the predetermined range of quantities.

13. The method of claim 11, wherein sending, to the client device, the first segment and the first randomly selected quantity of additional segments comprises:
sending, at a first time and based on the first segment becoming available to the at least one server, the first segment; and
sending, at a second time and based on a second segment of the first randomly selected quantity of additional segments becoming available to the at least one server, the second segment, wherein the second time occurs after the first time.

14. The method of claim 11, further comprising:
based on sending, to the client device, the first segment and the first randomly selected quantity of additional segments, sending a message to the client device, wherein the message indicates to the client device that transfer of the first segment and the first randomly selected quantity of additional segments is complete.

15. The method of claim 14, further comprising:
based on sending the message, receiving, from the client device, a request for a second segment of the plurality of segments of the content item;
determining, based on the manifest associated with the content item, a second randomly selected quantity of additional segments of the plurality of segments, wherein the second randomly selected quantity of additional segments is different from the first randomly selected quantity of additional segments; and
sending, to the client device, the second segment and the second randomly selected quantity of additional segments.

16. The method of claim 11, wherein the first segment and the first randomly selected quantity of additional segments comprise consecutive segments of the plurality of segments.

17. A method comprising:
receiving, by at least one server and from a first client device, a request for a first segment of a plurality of segments of a content item;
determining a first randomly selected time within a predetermined time window; and
sending, to the first client device and at the first randomly selected time, the first segment.

18. The method of claim 17, further comprising:
receiving, by the at least one server and from a second client device, a request for the first segment;
determining a second randomly selected time within the predetermined time window, wherein the second randomly selected time is different from the first randomly selected time; and
sending, to the second client device and at the second randomly selected time, the first segment.

19. The method of claim 18, further comprising:
based on sending the first segment to the first client device at the first randomly selected time, receiving, from the first client device and at a first time, a request for a second segment of the plurality of segments; and
based on sending the first segment to the second client device at the second randomly selected time, receiving, from the second client device and at a second time, a request for the second segment, wherein the first time is different from the second time.

20. The method of claim 17, wherein the predetermined time window comprises a period of time in between the first client device sending the request for the first segment and a scheduled output time associated with the first segment.
